(19) United States
(12) Patent Application Publication
(10) Pub. No.: US 2026/0291988 A1
(43) Pub. Date: Sep. 24, 2026

(54) SYSTEM AND METHOD FOR IDENTIFYING A PHISHING EMAIL

(71) Applicant: KraLos GmbH, Burgdorf (DE)

(72) Inventors: Christian Clemens Greiwe, Sundern (Sauerland) (DE); Carsten Klein, Burgdorf (DE)

(21) Appl. No.: 19/085,814

(22) Filed: Mar. 20, 2025

(51) Int. Cl. H04L 9/40

(52) U.S. Cl. CPC H04L 63/1483; H04L 63/1416

(57) ABSTRACT

Computerized system for detecting a phishing attempt, system including: computing devices with output devices. Program product including machine-readable program code for causing, when executed, computing device to perform following process steps: a) loading phishing detection application upon opening of potential harmful link; b) forwarding query with potential phishing attack from browser to proxy; c) forwarding information of query from the proxy to securing unit, the securing unit transmits the received information to a scanning unit and an inspection unit, i) scanning unit forwards information to a verification unit and/or a resource control unit, and the verification unit examines the information on potential harmful indicators; the resource control unit checks whether functions of web resource are correct; and the scanning unit receiving feedback from the verification unit and/or the resource control unit if a potential harmful query was identified, while transmitting the information to the securing unit.

### FIELD OF TECHNOLOGY

The present disclosure relates to the field of computer security, in particular, information security, e.g., to a system and a method of providing a phishing mitigation service.

### BACKGROUND

Phishing is an important threat to both enterprise and home computer users. In particular, phishing refers to a form of illegal activity intended to induce users into providing personal information, such as usernames, passwords, personal identification number, credit card data, Social Security number, tax information, or other sensitive data. In many cases, fraudsters, e.g., individuals using a computing device to perform a malicious act on another computer device user, try to deceive a user into visiting a fake site and entering their personal information. In order to induce a user into visiting a fake site. Usually, the attacker sends out an individually addressed email messages, mass email blast to a large number of email addresses or further communication messages such as SMS, MMS or the like. The phishing messages may use logos, fonts, backgrounds, and other visual elements selected e.g., from popular websites, services, work colleagues, bank employees, or representatives of a government agency. This creates a very sophisticated visual decoy that superficially appears to originate from the actual service. However, these messages contain a malicious link directing the user to a phishing website that mimics an official website. In another approach fraudsters use an attachment in the form of a file that also contains malicious links or exploits vulnerable applications to further compromise the user's computer, e.g., spyware, a virus, and/or other malware.

In former times, phishing attacks were less sophisticated, and only the highly credulous were generally susceptible to them. However, phishing attacks became more complex, and it can now be very difficult for even a skeptical user to detect phishing emails, or to separate phishing emails from non-phishing emails. Accordingly, in case of professional emails, some employees cannot be blamed for their behavior.

Phishing represents a substantial danger to both enterprise and home users' data. A number of existing techniques for identifying a phishing email exist, e.g., regular expression matching, machine learning, visual identification, and others. In addition, there exist computer programs designed to detect and block phishing emails. However, phishing attacks are constantly being modified by fraudsters to evade forms of detection. Furthermore, most of the known methods does not have a 100% detection rate and a 0% false positive rate. Despite all technical possibilities and even with artificial intelligence (AI), it is not possible to prevent a phishing email from getting through to such an extent that no further damage can be done.

Accordingly, thus, phishing emails and other phishing messages cannot be completely prevented, the present invention is intended to detect phishing in an indirect manner and thereto separate phishing messages from non-phishing emails, and/or to ensured that clicking on the link, the document, page or other cannot lead to harmful consequences.

The embodiments described herein provide an easy way to ensure that users do not accidentally enter personal information to a fake site(s) of phishing emails or the like. This is also beneficial for less sophisticated users who can easily check the authenticity of an email by opening the link provided with the communication send.

### SUMMARY

Aspects of the disclosure relate to information security, more specifically, to systems and methods of indirectly identifying phishing emails. For example, the method of the present disclosure is designed to mitigate phishing email messages while creating a safe surrounding to identify trustworthy communication and simultaneously reducing the number of emails falsely identified as phishing communication by identifying the background information linked to the link.

The difference between the state of art and the present invention is the solution how phishing messages are identified. The commonly known services use tags or the addressee of, e.g., an email, to identify a potential phishing message directly. Usually this leads to a very high number of false positive hits. However, the present invention uses a new approach wherein potential phishing messages are identified indirectly. In particular, the system starts while the user actively opens a link or the like. Accordingly, every message is received by the user first. If the system recognizes a potential threat the connection is aborted.

In one exemplary aspect, a computerized system for detecting a phishing attempt, the system comprising: one or more computing devices with one or more output devices; and a program product comprising machine-readable program code for causing, when executed, the computing device to perform the following process steps: (a) loading a phishing detection application upon opening of a potential harmful website or document; (b) forwarding a query with a potential phishing attack from a browser to a proxy; (c) forwarding information of the query from the proxy to a securing unit, wherein the securing unit transmits the received information to a scanning unit and an inspection unit, wherein (i) the scanning unit forward information to a verification unit and/or a resource control unit, wherein the verification unit examines the information on potential harmful indicators; the resource control unit checks whether functions of a web resource are correct; and the scanning unit receiving feedback from the verification unit and/or the resource control unit if a potential harmful query was identified, while transmitting the information to the securing unit; (ii) the inspection unit comprising one or more data storages configured to store one or more listing for identifying unsafe and/or safe communications, queries or requests utilizing at least one deny list and an allowance list, wherein the inspection unit transmits the examined information to the scanning unit informing the securing unit if potential harmful information was identified; and (d) creating the potential harmful website in a headless browser without graphical output; (e) presenting the analysis received by the securing unit on one or more output device of the computing device. In a preferred embodiment, the phishing detection application is load after a user has actively opened a link received my a message, such a an email, SMS or the like.

In one embodiment the inspection unit receives information of the browser. In a preferred embodiment the inspection unit receives information of the browser via a network or a device if no redirection, and no external URL have been indicated.

In one aspect of the invention webpages and corresponding information on the deny list and/or allowance list are reviewed regularly.

In one embodiment the allowance list is a user-verified list of domains, documents, pages, and/or other data, such as folders, files, containing information which has been identified as being not phishing sites or not containing viruses. In a further embodiment the allowance list has a “very safe”, “safe” and “probably safe” classification, wherein the system classifies a checked page as “probably safe” if a webpage, information, document, data or resource has been checked several times with the conclusion that no fraudulent information has been found, preferably a “very secure” rating may be achieved if the user upgrades it from “secure” to “very secure”.

In one embodiment one or more output devices comprise display device, speaker and/or a haptic device.

In one aspect of the invention the transmission of the received information to a scanning unit and an inspection unit are performed parallel.

In one embodiment the verification unit determines potential phishing indicators comprising, e.g., (a) ownership of the domain; (b)registration date of the domain; (c) redirection of the website (URL redirection); (d) one or more keywords, preferably in the domain name and the Uniform Resource Identifier (URI); (e) malicious code in the JavaScript of the uniform resource locator (URL); (f) hidden links; and/or (g) listeners.

In one aspect the potential harmful website or document are examined by the verification unit although the scanning unit has detected potential redirection of the webpage.

In one embodiment, the headless browser unit uses the information of a web resource of the potential phishing website and information received by the resource control unit to build up a website in a headless browser.

In one aspect of the invention the scanning unit receives information that redirects have taken place from the inspection unit. The scanning unit may also provide an information to the user, an output device that the query is potentially harmful. In a further embodiment the scanning unit recognize viruses and/or malicious code in one or more documents, files and/or images from the web resource and if this is the case blocks the corresponding documents, files and/or images. The scanning unit may also make gradations for threats and return this result to securing unit, whereby these results are integrated by the securing unit into the website build by the headless browser unit to inform the user about potential threats.

In one embodiment, the resource control unit examines whether the functions of a domain, in particular a web resource are correct. In a preferred embodiment, resource control unit controls JavaScript functions in the URL, and provides the results to the securing unit.

In a further aspect of the present invention queries comprise attempts in form of a communication. These communications may comprise messages in form of a Short Message Service (SMS), Multimedia Messaging Service (MMS), Electronic mail (email), document, data forwarded to the user or may be directly opened by the user in a browser.

In one embodiment the inspection unit comprises one or more deny and/or allowance lists which are located in a cloud storage service (“cloud”).

In a further aspect, an artificial intelligence (AI) is used to detect malicious codes or listeners in the website and/or new examined websites to train with positive and/or negative results from potential target websites and incorporate the results to one or more lists of the inspection unit.

The method and system of the present disclosure are designed to provide information security, in a more optimal and effective manner, enabling legitimate emails to proceed towards the recipient while detecting malicious websites. Thus, in one aspect, the technical result of the present disclosure includes the indirect identification of phishing communications. In particular, by identifying the link and/or background information of the link incorporated within a potential phishing message. In another aspect, the technical result includes reducing the number of email messages falsely identified as phishing messages. In yet another aspect, the technical result comprises providing information security by blocking phishing messages.

### BRIEF DESCRIPTION OF THE DRAWINGS

FIG. 1 is a schematic overview of an exemplary areas of application of the present invention, wherein the exemplary system is used as a proxy between the user and the target on the internet as well as a scanner.

FIG. 2 illustrates a block diagram of an exemplary system used to implement a method for identifying a phishing email in accordance with aspects of the present disclosure.

FIG. 3 illustrates exemplary modules and reactions of the system to phishing email in accordance with aspects of the present disclosure.

FIG. 4 illustrates a schematic overview of an exemplary system, including a Cloud service with deny lists servers and virtual devices.

FIG. 5 a flow diagram of a process of an exemplary system used to implement a method for identifying a phishing email in accordance with aspects of the present disclosure.

### DETAILED DESCRIPTION

In the following detailed description, reference is made to the accompanying drawings, which form a part hereof, and in which is shown by way of illustration specific illustrative embodiments in which the invention may be practiced. In addition, the following disclosure provides many different embodiments, or examples, for implementing different features of the present disclosure. Specific examples of components and arrangements are described below to simplify the present disclosure. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Unless otherwise stated, a term as used herein is given the definition as provided in the A Dictionary of Computer Science, Oxford University Press, 2016 (7 ed.), ISBN 9780199688975.

It is to be noted that the term “a” or “an” entity refers to one or more of that entity; for example, “an unit,” is understood to represent one or more unit. As such, the terms “a” (or “an”), “one or more,” and “at least one” can be used interchangeably herein.

Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, display devices, or the like.

Unless specifically stated otherwise, it will be appreciated that throughout the description of the present invention, the phrase “(potential) phishing email” is not meant to be construed as limiting. The term “phishing email” utilized herein should encompass any communications, document, and/or data that are uninvited for an user and/or having, e.g., destructive or criminal function. Phishing emails have the intension to fraudulently induce disclosure of the recipients' personal information, including passwords, bank data, credit card information, and the like. Accordingly, “phishing email” may comprise spam communications, junk messages, and phishing emails.

The term “unit” is to be understood as one or a plurality of identical and/or different units. Units are also called “components” or “functional modules”. In addition, units may also be “computer executed” and/or “computer implemented”. The units may be implemented within a computer system that typically includes a processor and a memory. In general, a unit is meant to be a component of a system that performs specific operations to implement a specific functionality. Examples of functionalities include, but is not limited to, the processing of information. However, the units may also have further functionalities as described in the embodiments.

The term “unit” refers herein also to a tangible entity that is physically constructed, permanently configured (e.g., hardwired) or temporarily configured (e.g., programmed) to operate in a particular manner or to perform certain operations described herein. In embodiments where the units are temporarily configured (e.g., programmed), not every unit needs to be configured or instantiated at every point in time. For example, a general processor may be configured to execute different modules at different times. In some embodiments, a processor implements a unit by executing instructions that implement at least a portion of the functionality of the unit.

Optionally, a memory can store the instructions (e.g., as computer code) that is read and processed by the processor and causes the processor to perform at least some operations involved in implementing the functionality of the unit. Additionally or alternatively, in one embodiment, a memory, which may include one or more storage devices, may store data that is read and processed by the processor to implement at least a portion of the functionality of the unit. In another embodiment, the memory may include one or more hardware elements capable of storing information accessible to a processor. The memory may, in one embodiment, be at least partially a part of the processor or may be located on the same chip as the processor and/or may be a physical element separate from the processor. The at least one processor, in one embodiment, executes instructions stored in memory that perform operations involved in implementing the functionality of a particular unit. The at least one processor may also operate to support the performance of the relevant operations in a cloud computing or software-as-a-service (Saas) environment. For example, at least some of the operations involved in the implementation of a unit may be performed by a group of computers accessible over a network, such as the Internet, and/or through one or more appropriate interfaces, such as application program interfaces (APIs). Optionally, some of the units can be executed in a distributed manner between multiple processors. In one embodiment, the at least one processor may be located at one geographic location or distributed across multiple geographic locations. Optionally, some units may include the presentation of results on devices belonging to the user and/or located adjacent to the user(s). These devices include laptops, tablets, smartphones, but this list is not limited to those listed but can include any known device. Furthermore, in one embodiment, data can be uploaded to cloud-based servers. In some embodiments, units may provide information to other units and/or receive information from other units. Accordingly, such units can be considered communicatively coupled. If several such units are present at the same time, communications can be achieved through signal transmission. In embodiments where units are configured or instantiated at different times, communications between such units may be achieved, for example, by storing and retrieving information in memory structures accessible to multiple units. In one embodiment, a unit may perform an operation and store the output of that operation on a storage device to which it is communicatively coupled. Another unit can then access the storage device at a later time to retrieve and process the stored output.

The term “data” used herein generally relates to information, in any form. In particular, the term data comprises (characteristic) information, web resources, documents, files, images, back end information and the like.

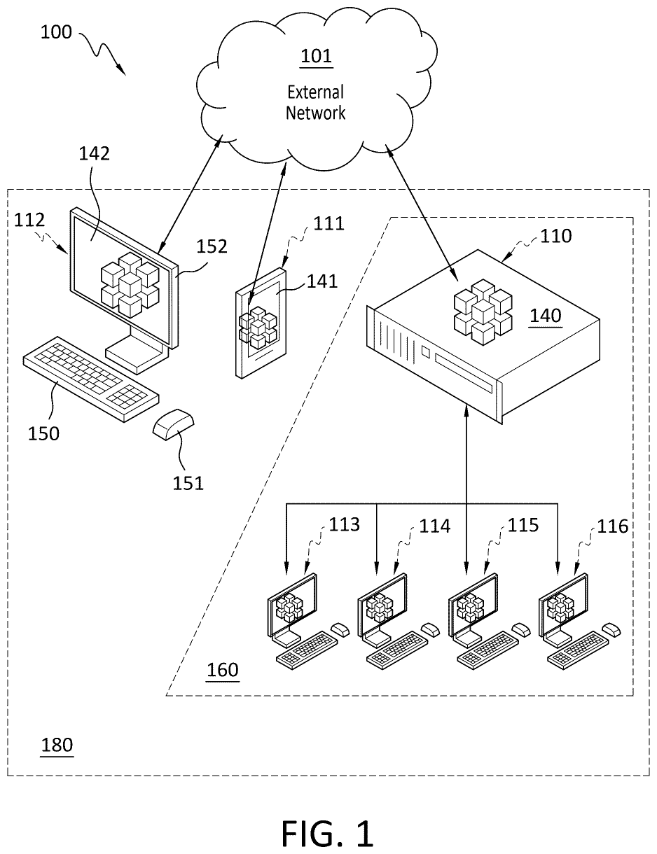

FIG. 1 depicts exemplary environments in which the exemplary system of the present invention may be used, in accordance with one embodiment. In the exemplary environment 100 includes components 180 such as computing devices 110, 111, and 112 which are communicatively coupled to an external network 101 such as the internet. However, the external network 101 may be any suitable type of network, including e.g., websites, servers, network protocols, and other network-based services. The number of computing devices 110, 111, 112 is exemplary in nature, and more or fewer number of devices may be present. A computing device 110, 111, 112 may include any computer including, but not limited to, one or more clients, a desktop computer, a server, a mobile computing device such as a tablet computer, a smartphone, or laptop computer, and a dumb terminal interfaced to a cloud computing system. The computing device 110, 111, 112 as well as 113, 114, 115, 116 may comprise one or more computer-readable media, such as, but not limited to the following listing, Random Access Memory (RAM); Read Only Memory (ROM); Electronically Erasable Programmable Read Only Memory (EEPROM); CD ROM, digital versatile disks (DVDs) or other optical or holographic media; flash memory or other memory technologies; magnetic cassettes, tapes, disk storage or other magnetic storage devices; or any other medium that can be used to encode desired information and be accessed by computing device. The memory (not shown) may comprise computer-storage media such as a volatile and/or non-volatile memory, which can be removable, non-removable, or a combination thereof. The memory may be, e.g., one or more solid-state memory, optical-disc drive(s), hard drive(s), or the like.

The computing device 110, 111, and 112 typically also comprise one or more processors which are able to process data from e.g., I/O components or memory. In one embodiment the processor is coupled to one or more display 152, input devices 150, and 151, such as a keyboard 150, mouse 151, speaker, printing device, and/or pointer, communication circuitry and the like. The display device 152, may be for example a monitor that displays information for viewing by a user of computing devices 112. The display device 152 may present rich content, e.g., a display area populated with representations of folders and/or digital communications or other forms of media such as audio signals, haptic signals, as well as uniform resource locator (URL) links that are active or deactivated. In addition, or alternatively, the display device 152 in one embodiment may be capable of rendering content associated with digital communications identified as legitimate or warning messages associated with digital communications identified as potential phishing email(s). The input device 150, and 152 for example a keyboard 150 and a mouse 151 are used to control a screen pointer provided by the graphical user interface on the computing device 112. I/0 ports (not shown) allow computing devices 110, 111, 112 as well as 113, 114, 115, 116 to be logically coupled to other devices including I/O components. Some of the devices including I/O components may in some aspects of the invention be built in.

The computing device 110, 111, and 112 may include a program product 140, 141, 142 including a machine-readable program code for causing, when executed, on the computing device 110, 111, 112 to perform steps of the present invention. The program product 140, 141, 142 may include software which may either be loaded onto the computing device 110, 111, and 112 or accessed by the computing device 110, 111, and 112. In one aspect of the invention the loaded software may also include an application for a mobile computing device 111. However, the software may also be accessed by the computing device 110, 111, and 112 using a web browser. The access of the software via the web browser via the computing device 110, 111, and 112 may be performed using the internet, intranet, extranet, haste server, internet cloud and the like.

One or more of the computing devices 110 may also be connected to further devices 113, 114 115, and 116. For example, in a company network a computing device 110 may comprise the exemplary system 140 and provide save information to the users of the other devices 113, 114 115, and 116. In another embodiment the other devices 113, 114 115, and 116 may also include an exemplary system (not shown). The other devices 113, 114 115, and 116 may be one or more of a client, a desktop computer, a server, a mobile computing device such as a tablet computer, a smartphone, or laptop computer, and a dumb terminal interfaced to a cloud computing system.

However, the system and method of the present invention are not limited to a particular type of network to which the computing devices 110, 111, 112, 113, 114, 115, and 116 are connected. Those skilled in the art will appreciate that the system and method described herein can be applied to virtually any network without departing from the scope of the claims and specification. In one embodiment a network connecting the computing devices include, but is not limited to, general-purpose systems such as ISDN (Integrated Services Digital Network), special-purpose systems such as LAN (local area network) or a WAN (wide-area network).

The network illustrated in FIG. 1 shows an exemplary local network 160 in form of a single network. However, in another embodiment the network 160 may include also one or more networks, e.g., various intranets which may be connected to the Internet. The local network 160 may be also be configurated to allow access to an external network 101, e.g., the Internet, wherein the connection is preferably performed via a gateway (not shown). The gateway may be responsible for providing a logical boundary between local network 160 and external network 101.

The external network 101 presented in FIG. 1 and already described above, is of exemplary nature and should illustrate, e.g., requests, data, documents and other information received through an external source such as the internet. In one embodiment a fraudster may connect with the external network 101. Accordingly, the information received by the network 101 may include malicious codes, data or other information which may be transmitted or shown on one or more of the of computing devices 110, 111, 112. Individuals of one or more of computing devices 110, 111, and 112 may notify via the exemplary system 140, 141, and 142 that a received message or information is a possible phishing attack. The exemplary system 140, 141, 142 in one embodiment may be a proxy that is integrated into a company network 160 as an independent device or an internal virtual proxy, in particular used for computing devices 111, 112, such as, e.g., desktop computer 112 and mobile computing devices 111. Via the exemplary system 140, 141, 142 information received from the external network 101 are scanned, resources are downloaded and checked for malicious code, and/or domain affiliation is checked, before the information is sent to the user. In the event of suspicion, the information, resource or page is retained and the user is informed.

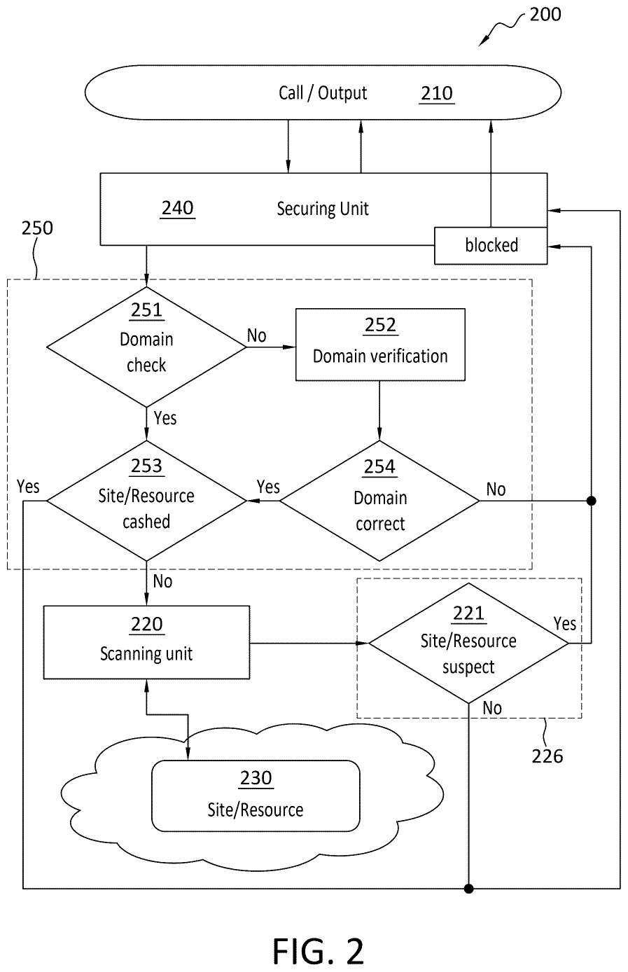

It should be understood and appreciated that the exemplary system 200 shown in FIG. 2 is merely an example of steps that may be performed by the system 200 and is not intended to suggest any limitation as to the scope of use or functionality of the present invention. In addition, the illustration should not be interpreted as having any dependency or requirement related to any single component or combination of components illustrated therein. The system 200 may be a virtual proxy which is located upstream of computing devices and/or integrated into the computing devices, i.e. into the network security device, such as a firewall. In a preferred embodiment the system 200 is a server device integrated into a computing device in a personal and/or company network or connected devices, such as routers. Accordingly, all queries 210 will be forwarded to the system 200 in form of a server device first.

The present system and method of the present invention is used to prevent a fraudster from receiving relevant information of a user. In this context, the system 200 includes a securing unit 240 which receives the queries 210 and identifies potential harmful information, such as phishing emails, malicious data, information and the like. The identification through the securing unit 240 comprise in one embodiment a verification of the domain through a verification unit 250.

The verification unit 250 may in one embodiment control potential indicators 251 for a malicious domain or the like. Due to the fact that pages of the phishing links, e.g., from emails, are discovered and shut down relatively quickly, fraudsters typically try to obfuscate phishing pages by locating them on other usually also hacked pages 252. In addition, the fraudsters may also use, e.g., browser switches to check which Internet Protocol address (IP address), web browser, and/or operating system the user has and thus redirecting calls from, e.g., authorities or cyber security companies to other sites. Accordingly, potential indicators 251 may comprise, but are not limited to, the ownership and/or registration date of the domain to be called up, redirection of websites (URL redirection), one or more keywords, in particular, in the domain name and the Uniform Resource Identifier (URI), e.g., “bank” or “insurance”. In another embodiment, further potential indicators 252 may be used such as the reputation of the domain owner, attachment files, and the like. Furthermore, the verification unit 250 determines whether there is a malicious code 253 in the JavaScript of the uniform resource locator (URL) and/or whether it contains hidden links or listeners.

In another embodiment of the present invention the system 200 comprise a scanning unit 220. The scanning unit 220 is responsible for forwarding requests and information to the verification unit 250 and a headless browser (not shown). The scanning unit 220 is connected to the external network, which may comprise malicious information. A domain check by the scanning unit 220 is considerably faster than the response from the headless browser (not shown). If the scanning unit 220 receives feedback 254 from the verification unit 250 and/or the resource control unit 226 identifying a potential phishing the query 210 will be blocked immediately. In one embodiment the resource control unit 226 may be part of the verification unit 250. The resource control unit 226 may also check JavaScript functions in the URL, e.g., comprising but not being limited to, potential loggers, e.g., retrieving data of a user by recording (logging) his action, hidden links, targets specified by forms displayed on the websites, emails or the like, viruses, vulnerable codes located, e.g., in files attached to an email. In one embodiment the securing unit 240 will provides an information to the user that a potential phishing email and/or domain has been identified.

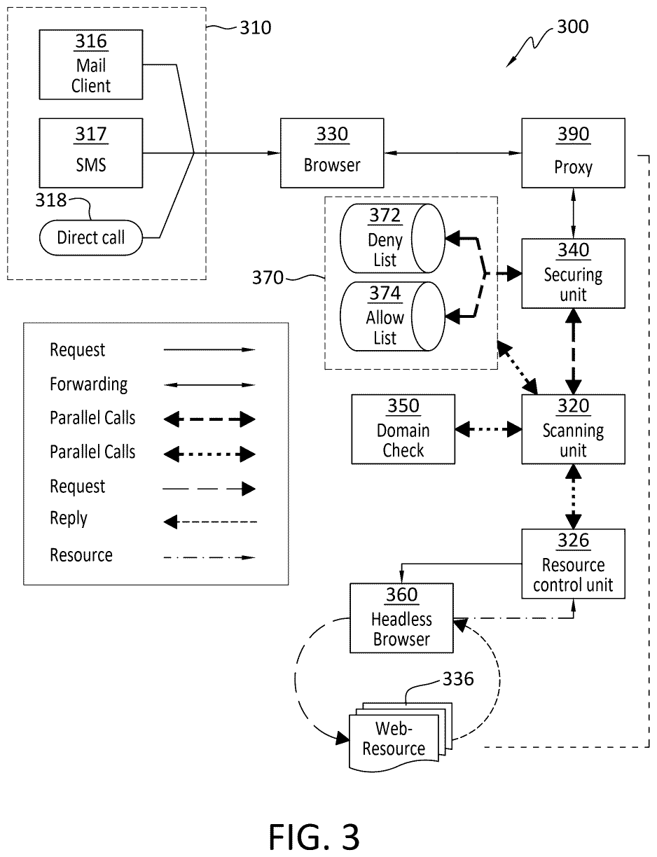

The block diagram in FIG. 3 illustrates an exemplary system 300 with exemplary modules and reactions of the system to a phishing attempt in accordance with aspects of the present invention. In operation, the units 320, 340, 350, 390, are designed to perform a process that includes, at least, the determination of a potentially phishing attempt, in form of, e.g., an email, or malicious data, such as a document, file, link or the like. Many phishing pages are subpages or subdomains of hacked pages. The target pages of a phishing link either point directly to a phishing page or redirect the call to another, usually also hacked page. The redirection is carried out, for example, to avoid having to rebuild the fake page, e.g., a bank login, if the target page of the phishing link is shut down by the authorities. In addition, a check of the calling system is carried out on the phishing link target page in order to redirect to another, usually unhacked, page in the event of suspected detection, e.g. by the authorities. In case the system 300 identifies an unsafe status unsafe status, the system 300 will inform the user of a potentially phishing email and/or an unsafe document, link or the like. In this context, in one embodiment, the system 300 may limit the actions requested by the user.

Queries 310 may be phishing attempts in form of a communication, e.g., a message in form of a Short Message Service (SMS) 317, Multimedia Messaging Service (MMS), Electronic mail (email) 316, document, data, or other forms of communication 318 that may be intended to comprise destructive or criminal functions, may be forwarded to a user or may be directly opened by the user, e.g., in a browser. The queries 310 may be one or more nefarious entities, such as fraudsters or illegal computer programs, that transmit to the user communication 316, 317, and/or 318 that fraudulently induce disclosure of the user's personal information. For the sake of simplicity, the further process is described in view of an opened link of a potential phishing email directing the user typically to a browser 330.

The queries 310 of the corresponding link, the user or the like, is forwarded in a first step to a proxy 390. In computer networking, a proxy 390 or a proxy server acts as an intermediary between a client requesting a resource and the server providing that resource. Usually, a proxy 390 is used for security reasons, improving privacy, security, and possibly performance in the process, by evaluating the request and performing the required network transactions. In addition, by using a proxy 390, the IP address of a computing device, as described to FIG. 1, can also be disguised, due to the fact that the computer addressed only receives the IP address of the proxy 390. The forwarding of the corresponding information or requests may be set up system-wide, e.g., in form of a proxy server; virtually, e.g. in form of a virtual proxy for example used in mobile devices; or defined in the browser 330.

In a further step of the method of the exemplary system 300 the queries 310 or requests are forwarded from the proxy 390 to a securing unit 340. In one embodiment, the securing unit 340 receives the queries 310 and checks the queries 310 for potential injections or potential harmful information, e.g., viruses, vulnerable codes located, or the like. This check performed by the securing unit 340 should ensure that own web applications, e.g., in the intranet, are not attacked by an infected query 310 or device. Accordingly, in one embodiment queries 310, such as resources, page, documents, or other information, is not sent directly to the user. All requests are provided to the securing unit 340 and then sent from there to the external network, such as the internet. The responses received from the external resource, e.g., the internet is checked by the system 300, in particular the securing unit 340 and provided to the necessary units and/or the user. In this way, the system 300 decouples the queries 310 from the Internet. In one embodiment

In a further embodiment the securing unit 340 transmits a request comprising the potential harmful information of the query 310 to an inspection unit 370. The inspection unit 370 may comprise a data storage, such as one or more computer-readable media and/or computer-storage media, such as, but not limited to the following listing, Random Access Memory (RAM); Read Only Memory (ROM); Electronically Erasable Programmable Read Only Memory (EEPROM); CD ROM, digital versatile disks (DVDs) or other optical or holographic media; flash memory or other memory technologies; magnetic cassettes, tapes, disk storage or other magnetic storage devices; or any other medium that can be used to encode desired information and be accessed by computing device, as well as volatile and/or non-volatile memory, which can be removable, non-removable, or a combination thereof, including, e.g., one or more solid-state memory, optical-disc drive(s), hard drive(s), or the like. The data storage in the inspection unit 370 are configured to store one or more listing for identifying unsafe and/or safe communications, queries or requests.

The inspection unit 370 may comprise a deny list 372 and/or an allowance list 374. Utilizing the inspection unit 370 the request or queries 310 it is determined whether an unsafe, or potentially phishing, digital communication is transmitted. For this reason, the deny list 372 may be generally configured to store information associated with persisting tags appended to digital communication(s) identified as being potentially phishing email(s) or potential harmful communication. Whereas, the allowance list 374 may be generally configured to store information associated with persisting tags appended to digital communication(s) identified as being safe. Typically, the listing acts as an index that enumerates each of the queries 310 identified as potentially harmful and/or safe that have arrived at the user's account. Preferably, the deny list 372 contains all known recognized phishing and vulnerability pages. Also hacked webpages which are commonly used for phishing may be incorporated to the deny list 372. The deny list 372 may be updated and checked in regular intervals. The intervals may be set by the user, a common entity, and/or a logical calculation of the system 300. In one embodiment the deny list 372 may be stored locally on one or more data stores of the system 300. However, the deny list 372 may also be compared with deny lists represented on the Internet. A corresponding comparison with information to potential harmful pages using the internet is particularly useful, in particular for phishing attacks as the fraudsters run real campaigns with newly hacked pages. This means that the site only has to be checked once, the information is then available to everyone else and the system 300 can very quickly issue a corresponding warning page to the user. Due to the fact that operators of the corresponding newly hacked webpages are often made aware of a potential compromising content, these webpages are cleaned up or completely relaunched. For this reason, webpages and corresponding information are not allowed to remain on the deny list 372 permanently. Accordingly, in one embodiment the deny list 372 is reviewed regularly for older entries. If cleaned up or completely relaunched websites or information are identified, the corresponding record may be removed from the deny list 372.

In one embodiment the allowance list 374 is a user-verified list of domains, documents, pages, and/or other data, such as folders, files, and the like, which is regularly checked. Preferably, the allowance list 374 contains all sites and domains which has been identified as being not phishing sites or do not contain viruses. The allowance list may be updated and checked in regular intervals. The intervals may be set by the user, a common entity, and/or a logical calculation of the system 300. Unlike the deny list 372, the allowance list 374 has no “yes” or “no” classification, but preferably a rating: “very safe”, “safe” and “probably safe”. The system 300 classifies a checked page as “probably safe”. If a webpage, information, document, data or resource has been checked several times, the system classifies it as “safe”. The “very secure” rating may be achieved if the user upgrades it from “secure” to “very secure”. As described above in view of the deny list 372, websites may be hacked. As a result, the system 300, preferably the inspection unit 370 evaluate pages, documents, and the like with “secure” and “probably secure” regularly.

In one embodiment the lists may comprise, e.g., email IDs which were identified as unsafe or safe. Although the inspection unit 370 comprising a deny list 372 and/or an allowance list 374 has been illustrated as single, independent unit, the inspection unit 370 may comprise one or more data stores, such as a plurality of databases which may also be located in different places, such as for instance, a database duster, personal computing device, a (web) server, any another external computing device and/or any combination thereof. In case, the inspection unit 370 identifies the query as malicious a negative response is transmitted to the securing unit 340. In one embodiment the securing unit 340, after receiving negative feedback of the inspection unit 370, causes an immediate abort of the query 310. The securing unit 340 may provide an information to the user, e.g. trough one or more output devices, such as a display device, speaker, haptic device that a potentially communication, in form of an email, text, document or the like, have arrived at the user's account and have been identified as having an unsafe status. If a positive response is received by the allowance list 374 first, a a corresponding webpage, document, information or the like is retrieved from the memory (not shown), if available. If no stored resource of the query 310 exists a scanning unit 320 is instructed to fetch the corresponding webpage, document, information or the like without checking. This is intended to keep the latency as low as possible.

In one embodiment the securing unit 340 may send the request or provided information to the deny list 372, allowance list 374 and/or a scanning unit 320 in parallel. In a preferred embodiment the first negative response by any of the units, i.e., deny list 372, allowance list 374, scanning unit 320 and/or a resource control unit 326 may cause an immediate abort of the process, wherein the securing unit 340 informs the user of a potential fraudulent query 310. This information may comprise, e.g., a visual representation on an output device that the query 310 is potentially harmful.

In on embodiment of the present invention the securing unit 340 transmits a request to a scanning unit 320. The scanning unit 320 receives requests from the securing unit 340 comprising, e.g. information to a potential harmful query, such as a communication in form of an email, a file, a text, a SMS, or the like. The scanning unit 320 may forward information in form of received communications to the verification unit 350 and/or the resource control unit 326. In one embodiment the scanning unit 320 may also be connected directly to an external network comprising or receiving potential harmful queries 310. In one embodiment, the scanning unit 320 receives information that redirects have taken place from the inspection unit 370. Accordingly, these redirects of the domain may be reviewed in detail by a verification unit 350.

The verification unit 350 may check the information of the domain to be called up in one embodiment. As already described to FIG. 1, the verification unit 350 may in one embodiment control potential indicators for a malicious domain, e.g., but not limited to ownership and/or registration date of the domain to be called up, redirection of websites (URL redirection), one or more keywords, in particular, in the domain name and the Uniform Resource Identifier (URI). In one embodiment the verification unit 350 examines the domain although the scanning unit 320 has detected potential redirection of the webpage. The verification unit 350 in a further step may transmit the examined information of the domain to the scanning unit 320 and/or send a command to the scanning unit 320 to inform the user of a potentially malicious domain, link, email, or the like.

If the scanning unit 320 receives feedback from the verification unit 350 and/or a resource control unit 326 that a potential harmful query 310 was identified, the scanning unit 320 will transmit the information to the securing unit 340. After receiving negative feedback of the scanning unit 320 regarding the query 310, the scanning unit 320 may provide an information to the user, as shown above, for example in form of a visual representation on an output device that the query 310 is potentially harmful. Although described as being sole and separate units, it should be understood and appreciated that the scanning unit 320, verification unit 350 and/or the resource control unit 326 may be separate parts comprising one or more data stores, such as a plurality of databases which may also be located in different places; or one unit, wherein one or more units are incorporated.

In one embodiment the scanning unit 320 provides request for, e.g., examination to the verification unit 350 and a headless browser 360 in parallel. A domain check is considerably faster than the response from the headless browser 360, and here too the process is aborted immediately if the verification unit 350 returns a negative result.

The resource control unit 326 examines whether the functions of a domain, in particular a web resource 336 are correct. In one embodiment the resource control unit 326 may check JavaScript functions in the URL, e.g., comprising but not being limited to, potential loggers, e.g., retrieving data of a user by recording (logging) his action, hidden links, targets specified by forms displayed on the websites, emails or the like, viruses, vulnerable codes located, e.g., in files attached to an email. However, the resource control unit 326 is not limited to JavaScript functions, also other programming language of the web technology may be used, such as, e.g., but not limited to WebAssembly, Java or the like. In an embodiment the resource control unit 326 may also examine file resources for viruses, vulnerability and the like. In particular, file resources define physical and operational characteristics of a file and provide, e.g., information about record characteristics, types of operations allowed on the file, operations that are to be journaled, recovery attributes, and the like.

Accordingly, in one embodiment the determination whether an unsafe, or potentially phishing, query 310 and/or web resource 336 is targeted involves checking a deny list 372 and/or an allowance list of the inspection unit 370 to ascertain whether the identification of the selected queries 310 or web resources 330 appears therein. In another embodiment, determining whether an unsafe digital communication is targeted involves inspection by the scanning unit 320 and/or resource control unit 326 to ascertain whether the queries 310 or web resources 336 appended with fraudulent information.

Websites herein refers to documents or files located on the World Wide Web. These websites may be accessed by using, e.g., a browser by specifying a Uniform Resource Locator (URL) and offered by a web server. The information of the websites, the browser, and the web server, and the like are summarized herein as web resource 336.

A unit called herein as headless browser 360 uses the information of the web resource 336 and information received by the resource control unit 326 to build up websites. The headless browser unit 360 may present the information without graphical output. This has the advantage that the web resources 336 are prepared like in a normal browser, including, e.g., Javascript. This is important because Javascript can perform nested calls that are difficult to recognize with a simple code examination. In addition, manufacturers of phishing sites prevent the sites from being examined if they are not real browsers. Accordingly, the headless browser unit 360 built up websites completely and the code from, e.g., Javascript, is processed. The headless browser unit 360 allows the user to view the content of websites in a protected environment. In one embodiment, in a further step a code, e.g., of Javascript, is integrated into the page. Furthermore, in the next step the code may be passed to the scanning unit 320 for examination. In case, the scanning unit 320 recognize a viruses and malicious code in a document, image or the like from the web resource 336, the corresponding information will be blocked. The headless browser unit 360 may design a virtual copy of the front end without data from the original websites. Accordingly, in one embodiment, only the digital twin remains accessible under for the user. This allows to fend off threats before they reach the real application on the computing devices.

The scanning unit may be able to make gradations for threats and return this information with the website to securing unit 340. Accordingly, information may be integrated by the securing unit 340 into the website build by the headless browser unit 360 to inform the user, e.g., that the web resource accessed may be dangerous. In one embodiment, the securing unit 340 may also send its own warning page back to the user, if a phishing page or a page with malicious code has been recognized.

Due to the security measures the user prevented from navigating to a fraudulent website by hiding the potentially phishing email, but can still access the contents of the potentially phishing email at the headless browser unit 360 to ascertain whether it is truly unsafe or uninvited.

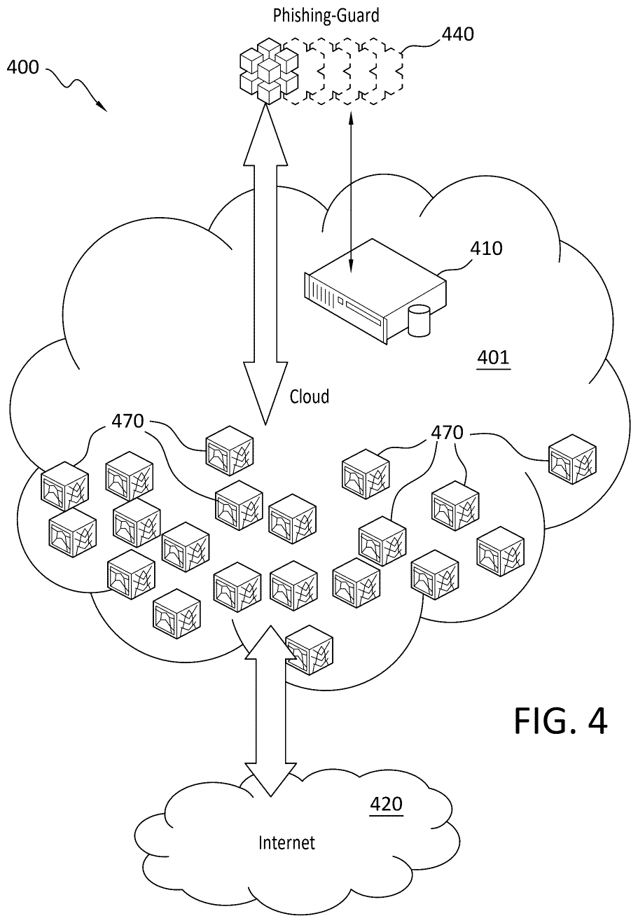

FIG. 4 illustrates a cloud storage service (“cloud”) 401 wherein the inspection unit 470 comprising one or more deny and/or allowance lists are located in a file hosting service. The cloud storage service 401 may allow users to access information, files, documents and the like over the internet. These information, files, etc. may comprise one or more deny and/or allowance lists. In addition, an artificial intelligence (AI) may be used to detect malicious codes or listeners. In one embodiment, the AI is trained with positive and/or negative results from potential target websites. In a further step, each result of a new websites may be integrated into a learning process, wherein the results are incorporated to one or more lists of inspection unit 470 comprising a deny and/or allowance list. This process continuously improves accuracy of the securing unit 440. In one embodiment, all information or resources that come from the internet are not delivered directly to the user. Preferably, only verified direct copies of information of websites are delivered to the user. It does not matter which application the request comes from.

The invention may also be described in form of computer code or machine-useable instructions, including computer-executable instructions such as program components, being executed by a computing device or other machine, e.g., a personal data assistant or other handheld device. In general, program components including routines, programs, objects, components, data structures, and the like, refer to codes that perform particular tasks or implements particular abstract data types. Accordingly, embodiments of the present invention may be practiced in a variety of system configurations, including mobile devices, consumer electronics, personal computers, company computing devices, or the like as well as distributed computing environments performing tasks by remote-processing devices that are linked through a communications network.

The methods and processes presented herein are not inherently related to any particular computing device or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with any computer system configuration, including personal computers, workstations, mobile devices, multiprocessor systems, microprocessor based, digital signal processor-based or other programmable consumer electronics, network computers that employ thin client architectures, minicomputers, mainframe computers, and the like. The invention can also be practiced in distributed computing environments where tasks are performed by remote processing devices that are linked through a communications network.

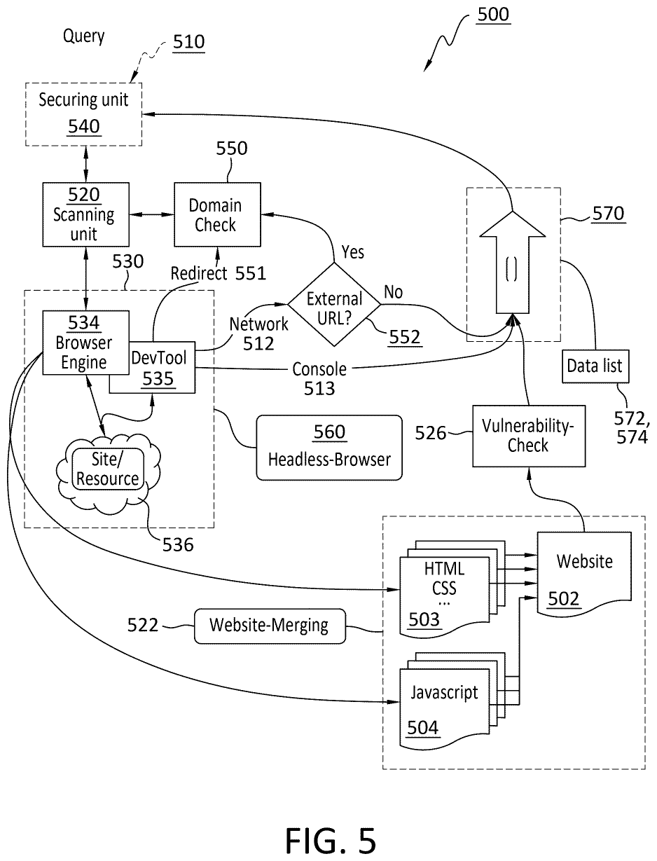

FIG. 5 illustrates a preferred embodiment utilizing a system of the present invention to recognizing potential malicious content of websites, in particular, in connection with a potential phishing email comprising a corresponding link.

In an exemplary method the user receives a phishing email with a link to a website. Using the link, the user is directed to a website or resource 536 on an internet browser 530. The method of the present invention receives information from browser engine 534. Browser engine are software components of web browser which, e.g., transform HTML documents and other resources of a web page into an interactive visual representation on a user's device. In addition, in one embodiment a developer tool 535 is used to identify potential bugs within command codes of a website. The information received by the website 536, the developer tool 535 and the browser engine 534 are forwarded to a scanning unit 520, a verification unit 550, and/or inspection unit 570.

The scanning unit 520 controls the requests and information received. In particular, in one embodiment the scanning unit 520 receives feedback from the verification unit 350 and/or the internet browser 530. Additionally, the scanning unit 520 may send a request to the verification unit 350 and/or the internet browser 530.

The verification unit 550 may check the information of the domain, such as, e.g., potential indicators for a malicious domain, e.g., but not limited to ownership and/or registration date of the domain to be called up, redirection of websites (URL redirection), one or more keywords, in particular, in the domain name and the Uniform Resource Identifier (URI). The verification unit 530 may receive information of a website in view of a redirection 551 or, e.g., whether an external URL was used, by the development tool 535. The verification unit 550 in a further step may transmit the examined information of the domain to the scanning unit 520 and/or send a command to the scanning unit 520 to inform the user of a potentially malicious domain, link, email, or the like.

After receiving all relevant information, the scanning unit 520 may transmit the information to the securing unit 540. The securing unit receive the processed information of the units whether a potential harmful information, such as phishing emails, malicious data, information and the like, was received by the user. If this is the case, the securing unit 540 sends feedback to the user, e.g., in form of a visual, haptically and/or acoustical output.

In a further step, in one embodiment the browser engine 534 may receive information to the corresponding websites 502 in the, e.g., JavaScript functions 504 in the URL, design languages of the websites 503, such as JavaScript (JS), Cascading Style Sheets (CSS), Hypertext Markup Language (HTML) or the like. The output of the information may be transmitted to a resource control unit 526 which examines whether the functions of the website 502 are correct. As already described to FIG. 3, the resource control unit 526 may check functions in the URL, such as potential loggers, e.g., retrieving data of a user by recording (logging) his action, hidden links, targets specified by forms displayed on the websites, emails or the like, viruses, vulnerable codes located, e.g., in files attached to an email.

The resource control unit transmits the information received from the website 502 to the inspection unit 570. The inspection unit 570 comprise one or more lists which website are harmful or safe. These data lists 572, 574 comprise deny list and allowance lists as described to FIG. 3. In one embodiment the inspection unit 570 also receive information of the browser 530 via a network 512 or a device 513 if no redirection, and no external URL have been indicated. After checking the information of the website with the stored data lists 572, 574 the inspection unit provide feedback to the securing unit 540. In case a malicious information has been found the securing unit 540 sends feedback to the user, e.g., in form of a visual, haptically and/or acoustical output.

In parallel the headless browser unit 560 creates a twin of the website utilizing information of the web resource 336 and information received by browser 530. In one embodiment the headless browser unit 560 present the information without graphical output. The headless browser unit 560 allows the user to view the content of websites in a protected environment.

Accordingly, the present invention identifies potential phishing attempts indirectly, due to a cascade which is started upon a user press a link or the like in a communication, such as an email, a SMS, a MMS or the like. The present system 100, 200, 300, 400, 500 checks the linked website, document or other relevant data to ensure that no malicious information is based on it. If so, the user receives an information that the linked document, website or the like is malicious. However, none of the communications, such as emails, SMS or the like are directly ignored or marked as being probably phishing.

Exemplary aspects are described herein in the context of a system, method, and a computer program for identifying phishing emails in accordance with aspects of the present disclosure. It is to be understood that the above description is intended to be illustrative, and not restrictive. Other aspects will be apparent to those of skill in the art upon reviewing the above description. The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein. The scope of the invention should, therefore, be determined with reference to the appended claims, along with the full scope of equivalents to which such claims are entitled. This listing of claims will replace all prior versions, and listings, of claims in the application.

1. A computerized system for accessing a website on an external network and detecting a phishing attempt, the computerized system comprising:
one or more computing devices with one or more output devices; and
a program product comprising a machine-readable program code for causing, when executed, the one or more computing devices to perform the following:
a) loading a phishing detection application upon opening of a potential harmful link;
b) forwarding all weblinks with a potential phishing attack from a browser to a web proxy;
c) forwarding information of the forwarded weblinks from the web proxy to a securing unit, wherein the securing unit transmits the forwarded information of the forwarded weblinks from the web proxy to a scanning unit and an inspection unit, wherein the inspection unit inspects the forwarded information of the forward weblinks from the web proxy and transmits the inspected information to the scanning unit which informs the securing unit if potential harmful information was identified, and wherein:
i) the scanning unit forwards the forwarded information of the forwarded weblinks from the web proxy from the securing unit to a verification unit and/or a resource control unit, wherein
the verification unit examines the forwarded information of the forwarded weblinks from the web proxy for potential harmful indicators;
the resource control unit checks whether functions of a web resource are correct; and
the scanning unit receives feedback from the verification unit and/or the resource control unit if a potential harmful website was identified, while transmitting the information to the securing unit; and
ii) the inspection unit comprises one or more data storages configured to store one or more listings for identifying unsafe and/or safe communications, queries or requests utilize at least one deny list and an allowance list wherein the inspection unit transmits the examined information to the scanning unit informing the securing unit if potential harmful information was identified;
d) accessing the potential harmful website in a headless browser without graphical output; and
e) presenting an analysis received by the securing unit on the one or more output devices of the one or more computing devices;
wherein the computerized system is configured to be implemented by a user on a computing device so as to detect and avoid phishing attempts.

2. The system according to claim 1, wherein the inspection unit receives information of the browser, via a network or a device if no redirection, and no external Uniform Resource Locator (URL) has been indicated.

3. The system according to claim 1, wherein webpages and corresponding information on the deny list and/or allowance list are reviewed regularly.

4. The system according to claim 1, wherein the allowance list
a) is a user-verified list of domains, documents, pages, and/or other data, folders, and/or files, containing information which has been identified as being not phishing sites or not containing viruses; and/or
b) has a “very safe”, “safe” and “probably safe” classification, wherein the system classifies a checked page as “probably safe” if a webpage, information, document, data or resource has been checked several times with a conclusion that no fraudulent information have been found.

5. The system according to claim 1, wherein the one or more output devices include display device, speaker, and/or haptic device.

6. The system according to claim 1, wherein the transmission of the received information to the scanning unit and the inspection unit are performed parallel.

7. The system according to claim 1, wherein the verification unit determines potential phishing indicators selected from the group consisting of:
a) ownership of a domain;
b) registration date of the domain;
c) redirection of a website (uniform resource locator (URL) redirection);
d) one or more keywords;
e) malicious code in a JavaScript of a uniform resource locator (URL);
f) hidden links; and
g) listeners.

8. The system according to claim 7, wherein the potential harmful website or document are examined by the verification unit although the scanning unit has detected potential redirection of a webpage.

9. The system according to claim 1, wherein the headless browser uses information of a web resource of a potential phishing website and communicates information received by the resource control unit to build up a website.

10. The system according to claim 1, wherein the scanning unit
a) receives information that redirects have taken place from the inspection unit;
b) provide an information to a user, an output device that a weblink is potentially harmful;
c) recognize viruses and/or malicious code in one or more data including documents, files and/or images from the web resource and if this is the case blocks the corresponding data, documents, files and/or images; and/or
d) makes gradations for threats and return the result of the gradations for threats to the securing unit, whereby the results of the gradations for threats are integrated by the securing unit into a website build by a headless browser unit to inform the user about potential threats.

11. The system according to claim 1, wherein the resource control unit examines whether functions of a domain and a web resource are correct, and provides results to the securing unit.

12. The system according to claim 1, wherein queries include attempts in form of a communication.

13. The system according to claim 1, wherein the inspection unit including the one or more deny lists are located in a cloud storage service (“cloud”).

14. The system according to claim 1, wherein an artificial intelligence (AI) is used to detect malicious codes or listeners in a website and/or new examined websites to train with positive and/or negative results from potential target websites and incorporate the results to one or more lists of inspection unit including a deny and/or allowance list.

15. The system according to claim 11, wherein the resource control unit examines whether functions of a domain, in particular Java Script functions in a uniform resource locator (URL) are correct and provides results to the securing unit.

16. The system according to claim 7, wherein the verification unit determines potential phishing indictors including one or more keywords, in the domain name and a Uniform Resource Identifier (URI).

17. The system according to claim 12, wherein queries include attempts in form of messages in form of a Short Message Service (SMS), Multimedia Messaging Service (MMS), Electronic mail (email), document, data forwarded to a user or is directly opened by the user in a browser.

18. The system according to claim 1, wherein the inspection unit including one or more allowance lists are located in a cloud storage service (“cloud”).
